(19) United States
(12) Patent Application Publication
(10) Pub. No.: US 2015/0084882 A1
(43) Pub. Date: Mar. 26, 2015

(54) ELECTRONIC APPARATUS, PROCESSING METHOD AND STORAGE MEDIUM

(71) Applicant: KABUSHIKI KAISHA TOSHIBA, Tokyo (JP)

(72) Inventor: Yoshikazu Terunuma, Ome-shi (JP)

(73) Assignee: KABUSHIKI KAISHA TOSHIBA, Tokyo (JP)

(21) Appl. No.: 14/265,207

(22) Filed: Apr. 29, 2014

(30) Foreign Application Priority Data
Sep. 25, 2013 (JP) 2013-198070

(51) Int. Cl. G06F 3/041; G06K 9/00; G09G 5/32

(52) U.S. Cl. CPC G06F 3/0416; G06F 3/0412; G09G 5/32; G06K 9/00409; G09G 2354/00
USPC 345/173

(57) ABSTRACT

According to one embodiment, an electronic apparatus includes a memory, a detector, a display controller, an input controller and a storage controller. The memory stores first stroke data corresponding to a first handwritten stroke. The first stroke data is stored in association with a first orientation of a screen. The detector detects a second orientation of the electronic apparatus. The display controller controls a third orientation of the screen by using the second orientation and displays the first handwritten stroke according to the third orientation. The input controller receives second stroke data corresponding to a second handwritten stroke. The storage controller stores the second stroke data corresponding to a second handwritten stroke in association with the third orientation.

### CROSS-REFERENCE TO RELATED APPLICATIONS

This application is based upon and claims the benefit of priority from Japanese Patent Application No. 2013-198070, filed Sep. 25, 2013, the entire contents of which are incorporated herein by reference.

### FIELD

Embodiments described herein relate generally to character recognition technology suitable for, for example, an electronic apparatus with a handwriting input function.

### BACKGROUND

In recent years, various electronic apparatuses such as a personal computer (PC) equipped with a touchscreen display, a tablet and a smartphone have become widespread.

An input operation using a touchscreen display is utilized for not only giving an operation instruction to an electronic apparatus, but also inputting documents and notes by handwriting.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment.

FIG. 2 is an exemplary block diagram showing a system configuration of the electronic apparatus according to the embodiment.

FIG. 3 is an exemplary illustration showing various utilization forms assumed in the electronic apparatus according to the embodiment.

FIG. 4 is an exemplary illustration showing an example of inputting characters by handwriting while changing (turning) an orientation of a screen in the electronic apparatus according to the embodiment.

FIG. 5 is an exemplary illustration showing a logical configuration of a stroke data storage region secured in the electronic apparatus according to the embodiment.

FIG. 6 is an exemplary illustration for illustrating a basic principle regarding handling of stroke data in the electronic apparatus according to the embodiment.

FIG. 7 is an exemplary first flowchart showing operation procedures regarding recognition processing of characters input by handwriting in the electronic apparatus according to the embodiment.

FIG. 8 is an exemplary second flowchart showing operation procedures regarding recognition processing of characters input by handwriting in the electronic apparatus according to the embodiment.

### DETAILED DESCRIPTION

Various embodiments will be described hereinafter with reference to the accompanying drawings.

In general, according to one embodiment, an electronic apparatus includes a memory, a detector, a display controller, an input controller and a storage controller. The memory is configured to store first stroke data corresponding to a first handwritten stroke input on a display. The first stroke data is stored in association with a first orientation of a screen displayed on the display at the time when the first handwritten stroke was input. The detector is configured to detect a second orientation of the electronic apparatus. The display controller is configured to control a third orientation of a screen displayed on the display by using the second orientation and to display the first handwritten stroke according to the third orientation. The input controller is configured to receive second stroke data corresponding to a second handwritten stroke input on the display. The storage controller configured to store the second stroke data in association with the third orientation at the time when the second handwritten stroke was input.

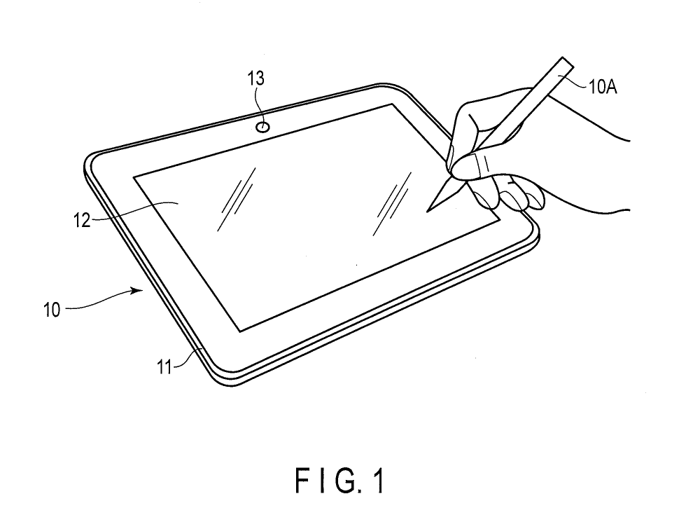

FIG. 1 is an exemplary perspective view showing an appearance of an electronic apparatus according to one of the embodiments. The electronic apparatus is, for example, a portable electronic apparatus capable of handwriting input by a stylus or a finger. The electronic apparatus can be implemented as a tablet computer, a notebook computer, a smartphone, a PDA, or the like. Hereinafter, it is assumed that the electronic apparatus is implemented as a tablet computer 10. The tablet computer 10 is a portable electronic apparatus called a tablet or a slate.

For example, the tablet can be used by turning the screen (changing the orientation of the screen). In general, displaying an image while orienting the long side of the rectangular screen horizontally is called landscape mode, and displaying an image while orienting the long side of the rectangular screen vertically is called portrait mode. Thus, handwriting input of characters can also be carried out from various directions with respect to the screen. More specifically, for example, after inputting n character strings by handwriting and changing an orientation of the screen, n+1th and following character strings can be input by handwriting.

On the other hand, in recognition processing of characters input by handwriting, recognition accuracy is high if the top and bottom of characters are aligned. In other words, recognition of characters of which top and bottom are not aligned is difficult and, even if these characters can be recognized, recognition accuracy is low. That is, recognition of characters input by handwriting while turning a screen in various directions was quite difficult.

As shown in FIG. 1, the tablet computer 10 includes a body 11, a touchscreen display 12 and a camera 13. The touchscreen display 12 is attached to a top surface of the body 11 to overlap the top surface. The camera 13 is attached to a periphery of the touchscreen display 12 on the top surface of the body 11.

The body 11 has a flat box-shaped housing. A flat panel display and a sensor configured to detect a contact position of a stylus or a finger on a screen of the flat panel display are incorporated into the touchscreen display 12. The flat panel display may be, for example, a liquid crystal display device (LCD). As the sensor, for example, a capacitive touchpanel, an electromagnetic induction type digitizer and the like can be used. Hereinafter, it is assumed that both two types of sensors, i.e., the digitizer and the touchpanel are incorporated into the touchscreen display 12.

Each of the digitizer and the touchpanel is provided to overlap the screen of the flat panel display. The touchscreen display 12 can detect not only a touch operation to the screen by a finger, but also a touch operation to the screen by a stylus 10A. The stylus 10A may be, for example, an electromagnetic induction pen. A user can carry out various gesture operations, for example, tap, drag, swipe, flick, etc., on the touchscreen display 12 by using the stylus 10A or a finger.

The user can carry out a handwriting input operation on the touchscreen display 12 by using the pen 10A. During the handwriting input operation, the path of movement of the stylus 10A on the screen, i.e., a stroke handwritten by the handwriting input operation (path of a handwritten stroke) is drawn in real time, and a plurality of handwritten strokes input by handwriting (the path of each handwritten stroke) are thereby displayed on the screen.

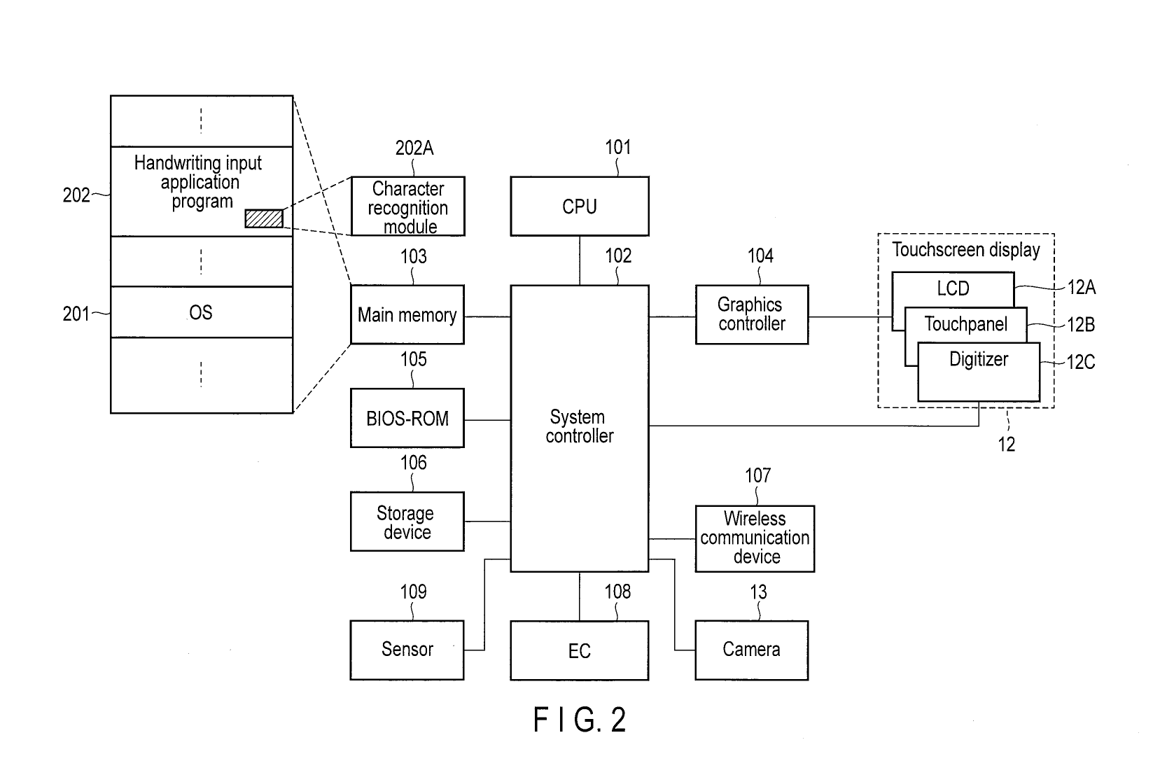

FIG. 2 is an exemplary illustration showing a system configuration of the tablet computer 10 according to the present embodiment.

As shown in FIG. 2, the tablet computer 10 includes a CPU 101, a system controller 102, a main memory 103, a graphics controller 104, a BIOS-ROM 105, a storage device 106, a wireless communication device 107, an embedded controller (EC) 108, a sensor 109 and the like.

The CPU 11 is a processor which controls operations of various types of modules in the tablet computer 10. The CPU 101 loads various types of programs from the storage device 106 into the maim memory 103 and executes the programs. The programs executed by the CPU 101 include an operating system (OS) 201 and various types of application programs such as a handwriting input application program 202. The handwriting input application program 202 is a program which executes the above-described processing regarding the handwriting input operation on the screen, and includes a character recognition module 202A which executes processing for recognizing characters expressed by strokes. The tablet computer 10 according to the present embodiment includes a new mechanism that the handwriting input application program 202 improves recognition accuracy of characters input by handwriting.

The CPU 101 also executes a Basic Input/Output System (BIOS) stored in the BIOS-ROM 105. The BIOS is a program for hardware control.

The system controller 102 is a device which connects between a local bus of the CPU 101 and various types of components. A memory controller which executes access control for the main memory 103 is built in the system controller 102. In addition, the system controller 102 includes a function to communicate with the graphics controller 104 via a serial bus.

The graphics controller 104 is a display controller which controls an LCD 12A used as a display monitor of the tablet computer 10. A display signal generated by the graphics controller 104 is sent to the LCD 12A. The LCD 12A displays a screen image based on the display signal. A touchpanel 12B is provided on an upper layer of the LCD 12A as a first sensor for detecting a contact position of a finger on the screen. In addition, a digitizer 12C is provided on a lower layer of the LCD 12A as a second sensor for detecting a contact position of the stylus 10A on the screen. The touchpanel 12B is a capacitive pointing device for executing input on the screen of the LCD 12A. The contact position on the screen which a finger touches, movement of the contact portion, etc., are detected by the touchpanel 12B. The digitizer 12C is an electromagnetic induction type pointing device for executing input on the screen of the LCD 12A. The contact position on the screen which the stylus 10A contacts, movement of the contact portion, etc., are detected by the digitizer 12C.

The OS 201 issues an input event indicating that a finger touched the screen and indicating the contact position, in cooperation with a driver program which controls the touchpanel 12B. Furthermore, the OS 201 issues an input event indicating that the stylus 10A contacted the screen and indicating the contact position, in cooperation with a driver program which controls the digitizer 12C.

The wireless communication device 107 is a device configured to execute wireless communication such as wireless LAN and 3G mobile communication.

The EC 108 is a single-chip microcomputer including the embedded controller for power management. The EC 108 includes a function to power on and off the tablet computer 10 in accordance with user operation of a power button.

The sensor 109 is an electronic circuit mounted to detect the orientation of the touchscreen display 12 and, for example, configured to detect a direction of gravity and outputs a detection signal indicating the detected direction of gravity.

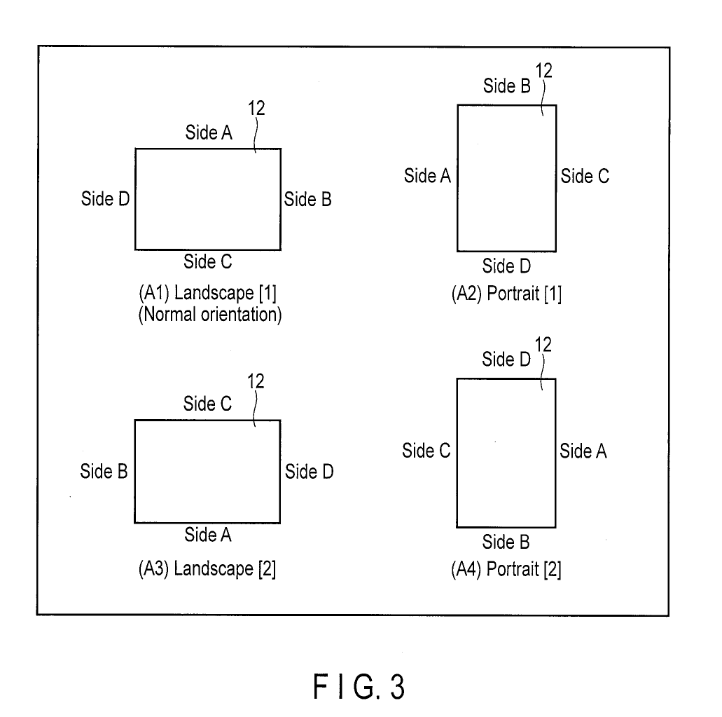

FIG. 3 is an exemplary illustration showing various utilization forms assumed in the tablet computer 10 according to the present embodiment.

As shown in FIG. 3, the tablet computer 10 can be used by orienting the touchscreen display 12 in various directions. Of the four sides of the touchscreen display 12 in FIG. 3, side A is that on which the camera 13 is arranged. First, the user can use the tablet computer 10 with the touchscreen display 12 oriented with side A at the top ((A1) in FIG. 3) so that the touchscreen display 12 extends horizontally. This orientation is called landscape mode. Here, it is assumed that the handwriting input application program 202 displays a handwriting input screen on the touchscreen display 12 in this (A1) state as a normal orientation.

Next, the user can use the tablet computer 10 with the touchscreen display 12 oriented with side A on the left ((A2) in FIG. 3) so that the touchscreen display 12 extends vertically. This orientation is called portrait mode.

Similarly, the user can use the tablet computer 10 with the touchscreen display 12 oriented with side A at the bottom ((A3) in FIG. 3) or on the right ((A4) in FIG. 3). The state (A3) is also called landscape mode like (A1), and is upside down with respect to (A1). The state (A4) is also called portrait mode like (A2), and is upside down with respect to (A2). The tablet computer 10 can detect these states (A1)-(A4) by the sensor 109.

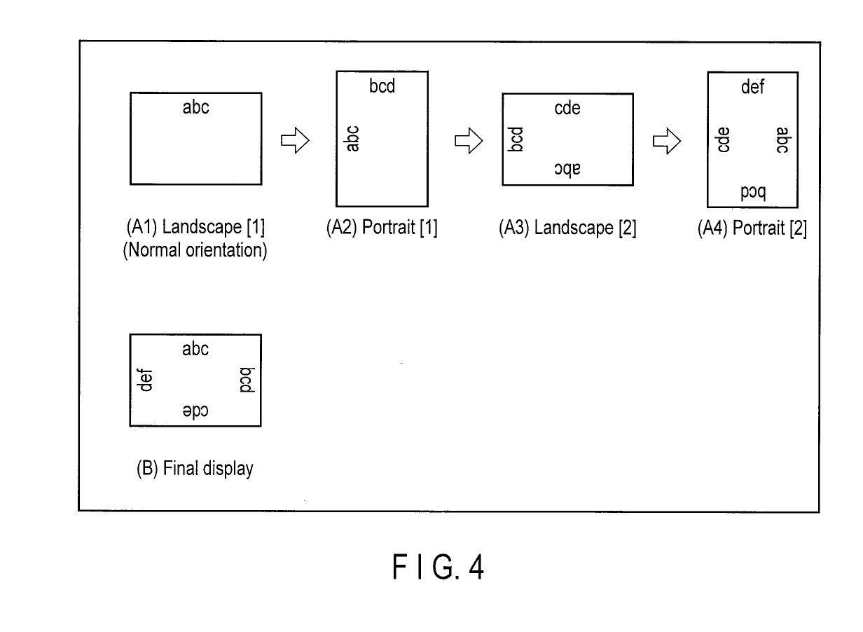

As described above, in the tablet computer 10 wherein the touchscreen display 12 can be used in various directions, characters can be input by handwriting on the touchscreen display 12 from various directions. FIG. 4 shows an example of inputting characters by handwriting while changing (turning) the orientation of the touchscreen display 12.

It is assumed that the user inputs “abc”, “bcd”, “cde” and “def” by handwriting while turning the touchscreen display in a counterclockwise direction.

That is, it is assumed that the user first holds the tablet computer 10 to allow the touchscreen display 12 to be in the state of (A1) in FIG. 3 and inputs “abc” by handwriting ((A1) in FIG. 4). Then, it is assumed that the user holds the tablet computer 10 to allow the touchscreen display 12 to be in the state of (A2) in FIG. 3 and inputs “bcd” by handwriting ((A2) in FIG. 4).

Similarly, it is assumed that the user holds the tablet computer 10 to allow the touchscreen display 12 to be in the state of (A3) in FIG. 3 and inputs “cde” by handwriting ((A3) in FIG. 4), and then holds the tablet computer 10 to allow the touchscreen display 12 to be in the state of (A4) in FIG. 3 and inputs “def” by handwriting ((A4) in FIG. 4). If handwriting input is carried out in such steps, a final display (of handwriting) on the touchscreen display 12 is the display in which the character strings “abc”, “bcd”, “cde” and “def” are arranged in different directions as shown in (B) in FIG. 4.

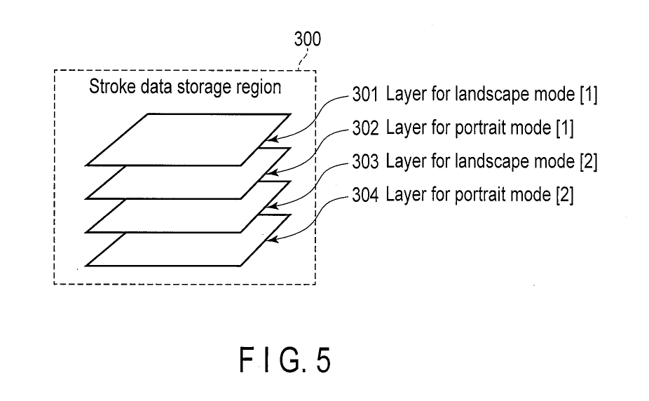

As shown in (B) in FIG. 4, recognition accuracy of characters of which top and bottom are not aligned generally declines. Thus, the handwriting input application program 202 which runs on the tablet computer 10 of the present embodiment is configured to prepare a memory region for storing data (stroke data) on the path of a handwritten stroke per direction of the touchscreen display 12 which can be detected by the sensor 109. FIG. 5 is an exemplary illustration showing a logical configuration of a stroke data storage region 300 secured in the tablet computer 10 by the handwriting application program 202.

The handwriting input application program 202 secures the stroke data storage region 300 for storing the stroke data in the storage device 106. Furthermore, as shown in FIG. 5, the handwriting input application program 202 logically divides the stroke data storage region 300 into four layers 301-304.

Layer 301 is a layer defined for the stroke at the time when handwriting input is carried out in a situation where the orientation of the touchscreen display 12 is supposed to be (A1) in FIG. 3 by the sensor 109. Layer 302 is a layer defined for the stroke at the time when handwriting input is carried out in a situation where the orientation of the touchscreen display 12 is supposed to be (A2) in FIG. 3 by the sensor 109.

Similarly, layer 303 is a layer defined for the stroke at the time when handwriting input is carried out in a situation where the orientation of the touchscreen display 12 is supposed to be (A3) in FIG. 3 by the sensor 109, and layer 304 is a layer defined for the stroke at the time when handwriting input is carried out in a situation where the orientation of the touchscreen display 12 is supposed to be (A4) in FIG. 3 by the sensor 109.

The example of logically dividing one stroke data storage region 300 secured in the storage device 106 into the plurality of layers 301-304 is described, but each of a plurality of stroke data storage regions 300 may be secured in the storage device 106 per orientation of the touchscreen display 12.

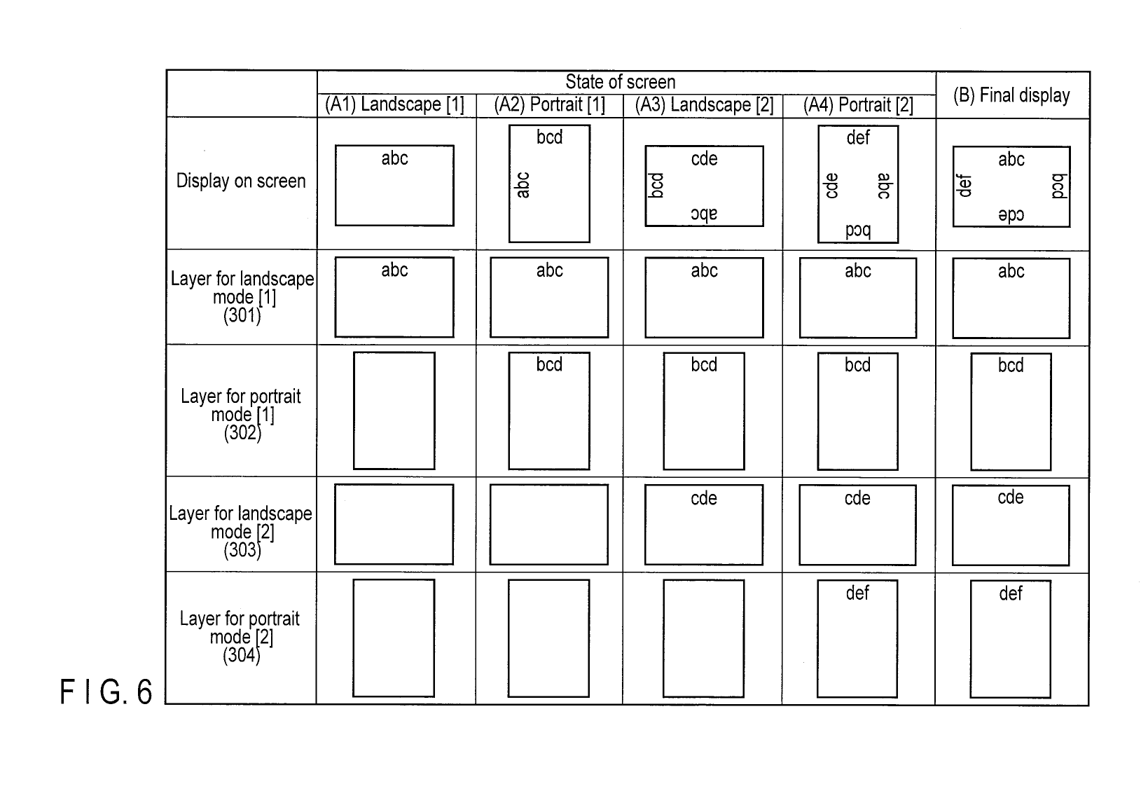

A basic principle regarding handling of the stroke data by the handwriting input application program 202 will be described with reference to FIG. 6. It is assumed that handwriting input on the touchscreen display 12 is carried out by the steps shown in FIG. 4.

When “abc” is input by handwriting, the handwriting input application program 202 determines that the orientation of the touchscreen display 12 is (A1) in FIG. 3, based on the detection signal output from the sensor 109, and stores the stroke data on “abc” in layer 301.

Next, when “bcd” is input by handwriting, the handwriting input application program 202 determines that the orientation of the touchscreen display 12 is (A2) in FIG. 3, based on the detection signal output from the sensor 109, and stores the stroke data on “bcd” in layer 302.

Similarly, when “cde” is input by handwriting, the handwriting input application program 202 determines that the orientation of the touchscreen display 12 is (A3) in FIG. 3, based on the detection signal output from the sensor 109, and stores the stroke data on “cde” in layer 303. When “def” is input by handwriting, the handwriting input application program 202 determines that the orientation of the touchscreen display 12 is (A4) in FIG. 3, based on the detection signal output from the sensor 109, and stores the stroke data on “def” in layer 304.

By storing the stroke data in the stroke data storage region 300 while allocating the stroke data to the plurality of layers 301-304 in accordance with the orientation of the touchscreen display 12 detected by the sensor 109, the top and bottom of the characters represented by the stroke data stored in each of layers 301-304 are aligned. The handwriting input application program 202 executes recognition processing of the characters by the character recognition module 202A with respect to each of layers 301-304 in consideration of the orientation of the characters assumed in each of layers 301-304.

The tablet computer 10 according to the present embodiment can thereby improve recognition accuracy of characters input by handwriting in a situation in which handwriting input is carried out from various directions on the touchscreen display.

It should be noted that the stroke data may be incorrectly allocated to each of layers 301-304 if, for example, the user carries out handwriting input while holding the tablet computer 10 in a slanting position or the user inputs slanting characters by handwriting. More specifically, the stroke data may be stored in a layer different from a layer in which the data should originally be stored. In this case, recognition processing executed by the character recognition module 202A would easily fail.

When recognition processing for stroke data of a layer executed by the character recognition module 202A fails, the handwriting input application program 202 may execute the recognition processing for the stroke data again on the assumption that the stroke data would be stored in another layer. A layer which should be assumed for executing the recognition processing again when the recognition processing fails may be predetermined, for example, per layer. This re-execution may be repeated (at most three times) until the recognition processing is successful while changing an assumed layer.

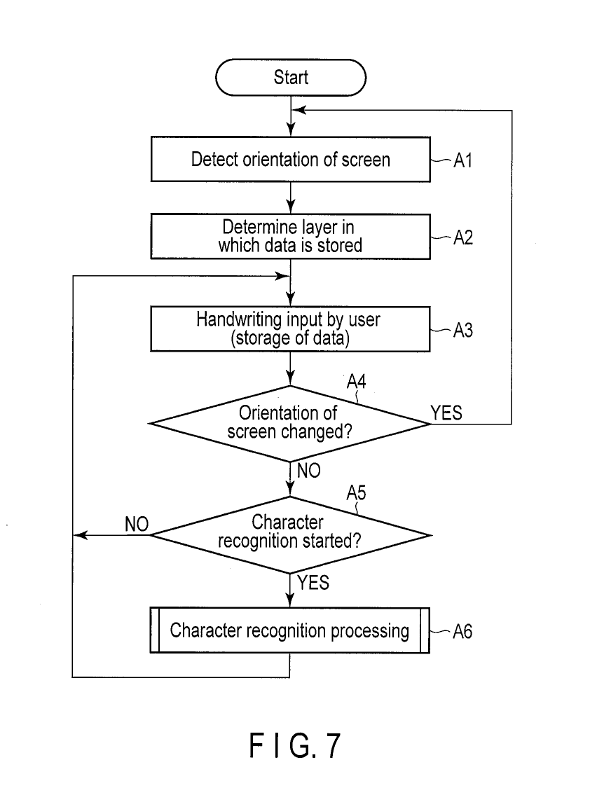

FIG. 7 is an exemplary flowchart showing operation procedures regarding the recognition processing of characters input by handwriting which are executed by the handwriting input application program 202 which runs on the tablet computer 10 according to the present embodiment.

The handwriting input application program 202 detects the orientation of the touchscreen display 12 based on the detection signal output from the sensor 109 (block A1). In accordance with the detected orientation, the handwriting input application program 202 determines a layer in which stroke data is stored when the handwriting input is carried out on the touchscreen display 12 (block A2). When the handwriting input is carried out on the touchscreen display 12 by the user, the handwriting input application program 202 stores the stroke data in the determined layer (block A3).

Based on the detection signal output from the sensor 109, the handwriting input application program 202 monitors whether the orientation of the touchscreen display 12 is changed (block A4). If the orientation of the touchscreen display is changed (YES of block A4), the handwriting input application program 202 executes the procedures of blocks A1-A2 again and re-determines a layer in which the stroke data is stored when the handwriting input is carried out on the touchscreen display 12.

Furthermore, for example, the handwriting input application program 202 monitors whether a touch operation for instructing execution of recognition processing of characters input by handwriting is executed (block A5) and, if the touch operation is executed (YES of block A5), executes recognition processing of characters by the character recognition module 202A (block A6).

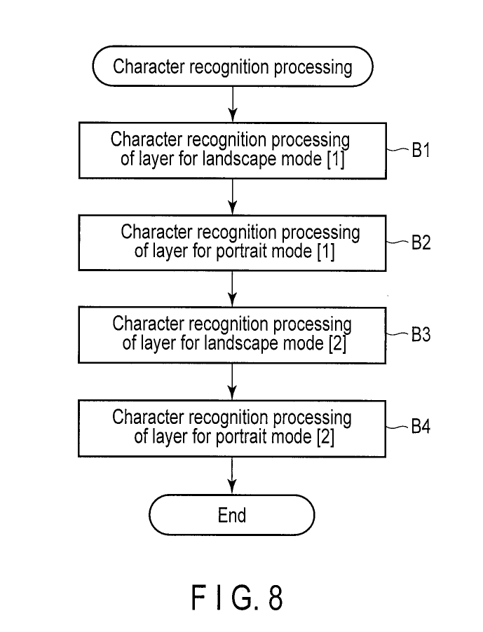

FIG. 8 is an exemplary flowchart showing operation procedures of recognition processing of characters executed by the character recognition module 202A.

The character recognition module 202A first executes recognition processing of characters represented by the stroke data stored in layer 301, of the stroke data stored in the stroke data storage region 300 (block B1). Then, the character recognition module 202A executes recognition processing of characters represented by the stroke data stored in layer 302 (block B2).

Similarly, the character recognition module 202A executes recognition processing of characters represented by the stroke data stored in layer 303 (block B3) and executes recognition processing of characters represented by the stroke data stored in layer 304 (block B4).

As described above, the tablet computer 10 of the present embodiment implements an improvement in recognition accuracy of characters input by handwriting, by the unprecedented idea of preparing the plurality of layers 301-304 in accordance with the orientation of the touchscreen display 12.

Since each of the procedures of the present embodiment can be executed by a computer program, the same advantage as the present embodiment can be easily achieved only by installing the computer program on a general computer through a computer-readable storage medium, which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a memory configured to store first stroke data corresponding to a first handwritten stroke input on a display, wherein the first stroke data is stored in association with a first orientation of a screen displayed on the display at the time when the first handwritten stroke was input;
a detector configured to detect a second orientation of the electronic apparatus;
a display controller configured to control a third orientation of a screen displayed on the display by using the second orientation and to display the first handwritten stroke according to the third orientation;
an input controller configured to receive second stroke data corresponding to a second handwritten stroke input on the display; and
a storage controller configured to store the second stroke data in association with the third orientation at the time when the second handwritten stroke was input.

2. The apparatus of claim 1, further comprising a recognition controller configured to execute processing for recognizing characters represented by the first stroke data and processing for recognizing characters represented by the second stroke data.

3. The apparatus of claim 2, wherein the recognition controller is configured to:
execute the processing for recognizing characters represented by the first stroke data again on an assumption that the first stroke data is the second stroke data, when recognition of characters represented by the first stroke data fails; and
execute the processing for recognizing characters represented by the second stroke data again on an assumption that the second stroke data is the first stroke data, when recognition of characters represented by the second stroke data fails.

4. The apparatus of claim 1, wherein the storage controller is configured to store the second stroke data in a first storage region corresponding to the third orientation.

5. The apparatus of claim 4, wherein:
the screen comprises a rectangle; and
the first storage region comprises two or four storage regions.

6. A processing method of an electronic apparatus, the method comprising:
storing first stroke data corresponding to a first handwritten stroke input on a display, wherein the first stroke data is stored in association with a first orientation of a screen displayed on the display at the time when the first handwritten stroke was input;
detecting a second orientation of the electronic apparatus;
controlling a third orientation of a screen displayed on the display by using the second orientation and displaying the first handwritten stroke according to the third orientation;
receiving second stroke data corresponding to a second handwritten stroke input on the display;
storing the second stroke data in association with the third orientation at the time when the second handwritten stroke was input.

7. The method of claim 6, further comprising executing processing for recognizing characters represented by the first stroke data and processing for recognizing characters represented by the second stroke data.

8. The method of claim 7, wherein the executing comprises:
executing the processing for recognizing characters represented by the first stroke data again on an assumption that the first stroke data is the second stroke data, when recognition of characters represented by the first stroke data fails; and
executing the processing for recognizing characters represented by the second stroke data again on an assumption that the second stroke data is the first stroke data, when recognition of characters represented by the second stroke data fails.

9. The method of claim 6, wherein the storing the second stroke data comprises storing the second stroke data in a first storage region corresponding to the third orientation.

10. The method of claim 9, wherein;
the screen comprises a rectangle; and
the first storage region comprises two or four storage regions.

11. A computer-readable, non-transitory storage medium having stored thereon a computer program which is executable by a computer comprising a memory configured to store first stroke data corresponding to a first handwritten stroke input on a display, the first stroke data being stored in association with a first orientation of a screen displayed on the display at the time when the first handwritten stroke was input, the computer program controlling the computer to function as:
a detector configured to detect a second orientation of the electronic apparatus;
a display controller configured to control a third orientation of a screen displayed on the display by using the second orientation and to display the first handwritten stroke according to the third orientation;
an input controller configured to receive second stroke data corresponding to a second handwritten stroke input on the display; and
a storage controller configured to store the second stroke data in association with the third orientation at the time when the second handwritten stroke was input.

12. The medium of claim 11, the computer program further controlling the computer to function as a recognition controller configured to execute processing for recognizing characters represented by the first stroke data and processing for recognizing characters represented by the second stroke data.

13. The medium of claim 12, wherein the recognition controller is configured to:
execute the processing for recognizing characters represented by the first stroke data again on an assumption that the first stroke data is the second stroke data, when recognition of characters represented by the first stroke data fails; and
execute the processing for recognizing characters represented by the second stroke data again on an assumption that the second stroke data is the first stroke data, when recognition of characters represented by the second stroke data fails.

14. The medium of claim 11, wherein the storage controller is configured to store the second stroke data in a first storage region corresponding to the third orientation.

15. The medium of claim 14, wherein:
the screen comprises a rectangle; and
the first storage region comprises two or four storage regions.
